(19) United States
(12) Patent Application Publication
(10) Pub. No.: US 2008/0248667 A1
(43) Pub. Date: Oct. 9, 2008

(54) POWER STRIP FOR COMPUTER AND RELATED COMPUTER PERIPHERALS

(75) Inventor: ZHENG-HENG SUN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/923,670

(22) Filed: Oct. 25, 2007

(30) Foreign Application Priority Data
Apr. 6, 2007 (CN) 200710200411.5

(51) Int. Cl. H01R 9/22

(52) U.S. Cl. 439/188

(57) ABSTRACT

A power strip includes a plug having a hot line terminal and a neutral line terminal, at least one outlet having a hot line terminal and a neutral line terminal, and a power control apparatus having a connector and an electrical switch. The neutral line terminal of the at least one outlet is electrically connected to the neutral line terminal of the plug. The connector is connected to a controlling portion of the electrical switch. The hot line terminal of the plug is connected to the hot line terminal of the at least one outlet via a switching portion of the electrical switch. If the connector is electrified, the controlling portion controls the switching portion to turn on thereby controlling the hot line terminal of the plug to be electrically connected to the hot line terminal of the at least one outlet.

### BACKGROUND

1. Field of the Invention

The present invention relates to power strips, and particularly to a power strip for providing power to computer peripherals according to status of their related computer.

2. Description of related art

A variety of electric strips have been disclosed for use to provide power. In order to provide power to a computer system and related computer peripherals such as monitors, printers, modems, speakers, scanners, digital camera and etc., multiple outlets may be necessary. Generally speaking, users can close the computer through an operating system thereof. However, the peripheral devices must be turned off manually, which is unduly laborious and time-consuming. Furthermore, users sometimes forget to turn off the peripheral devices, which may waste electricity and cause trouble.

What is desired, therefore, is to provide a power strip which overcomes the above problems.

### SUMMARY

An embodiment of a power strip includes a plug having a hot line terminal and a neutral line terminal, at least one outlet having a hot line terminal and a neutral line terminal, and a power control apparatus having a connector and an electrical switch. The neutral line terminal of the at least one outlet is electrically connected to the neutral line terminal of the plug. The connector is connected to a controlling portion of the electrical switch. The hot line terminal of the plug is connected to the hot line terminal of the at least one outlet via a switching portion of the electrical switch. If the connector is electrified, the controlling portion controls the switching portion to turn on thereby controlling the hot line terminal of the plug to be electrically connected to the hot line terminal of the at least one outlet.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is an isometric view of a power strip in accordance with an embodiment of the present invention; and

FIG. 2 is a circuit diagram of the power strip of FIG. 1, together with a computer.

### DETAILED DESCRIPTION

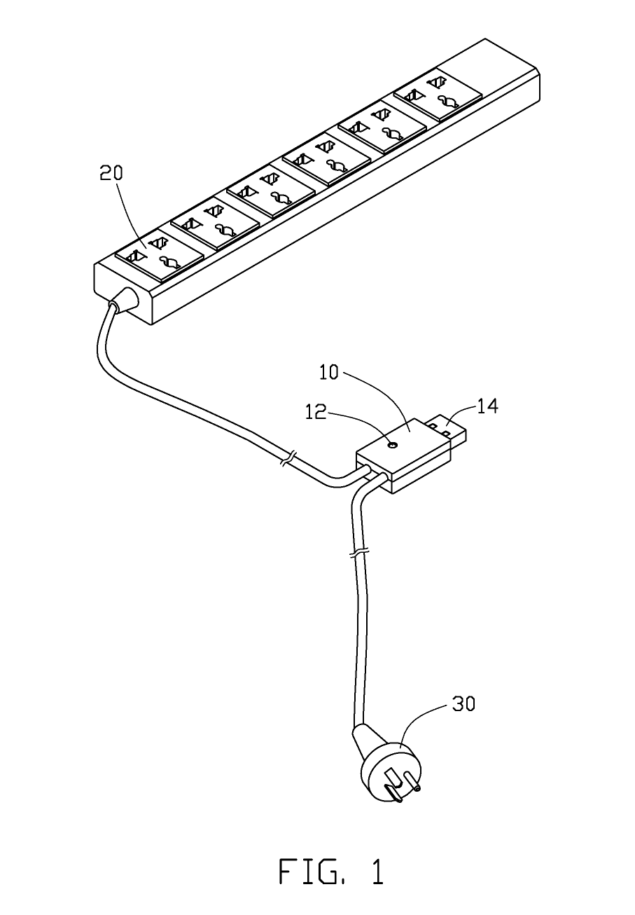

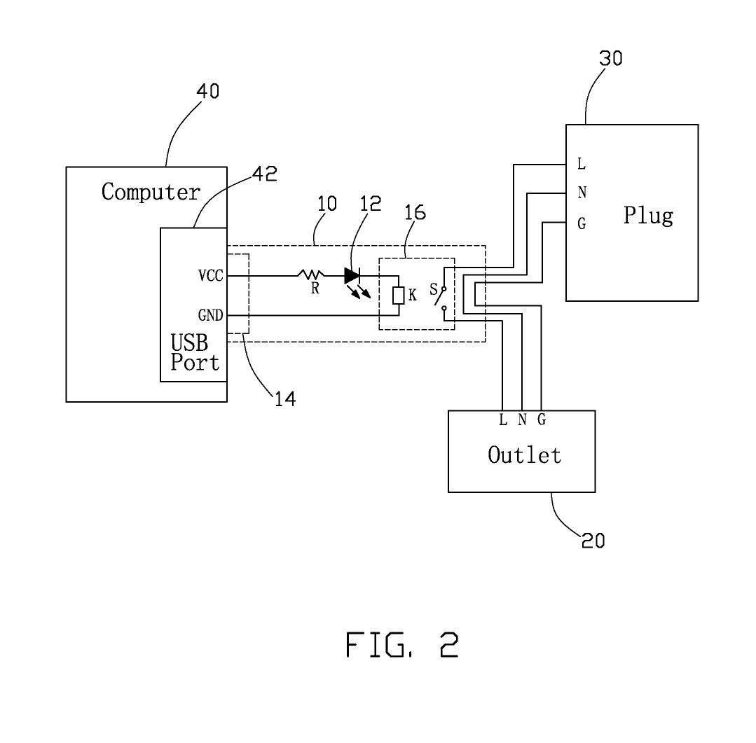

Referring to FIGS. 1 and 2, a power strip in accordance with an embodiment of the present invention includes a power control apparatus 10, a plurality of outlets 20, and a plug 30. Each outlet 20 includes a hot line terminal L, a neutral line terminal N, and a ground line terminal G. And, correspondingly, the plug 30 also includes a hot line terminal L, a neutral line terminal N, and a ground line terminal G.

The power control apparatus 10 includes a power-on indicator such as a light-emitting diode (LED) 12, a connector such as a universal serial bus (USB) connector 14, an electrical switch such as a relay 16, and a resistor R. The relay 16 includes an inductance coil K and a switch S controlled by the inductance coil K. The USB connector 14 includes a power terminal and a ground terminal. The power terminal of the USB connector 14 is connected to the anode of the LED 12 via the resistor R. The cathode of the LED 12 is connected to the ground terminal of the USB connector 14 via the inductance coil K of the relay 16. The hot line terminal L of each of the outlets 20 is connected to the hot line terminal L of the plug 30 via the switch S of the relay 16. The neutral line terminal N of each of the outlets 20 is connected to the neutral line terminal N of the plug 30. The ground line terminal G of each of the outlets 20 is connected to the ground line terminal G of the plug 30. The USB connector 14 also can be replaced by other connectors, which have power terminals and ground terminals.

In use, the plug 30 of the power strip is plugged into an external power supply (not shown). The USB connector 14 of the power control apparatus 10 is plugged into a USB port 42 of a computer 40. Power plugs of some peripheral devices (not shown), such as printers and scanners, are plugged into the outlets 20 of the power strip. When the computer 40 is turned on, the USB port 42 will be electrified. Thereby, the LED 12 is turned on, and then the switch S of the relay 16 is closed. Thereby, the peripheral devices are turned on. In another embodiment, the switch S of the relay 16 can be connected between the neutral line terminal N of each of the outlets 20 and the neutral line terminal N of the plug 30, and the hot line terminal L of each of the outlets 20 is connected to the hot line terminal L of the plug 30.

When users need to turn off the computer 40 and the peripheral devices, users can close the computer through an operating system thereof, and then the USB port 42 will be turned off. Thereby, the LED 12 is turned off, and the switch S of the relay 16 is opened. Thereby, the peripheral devices are turned off by means of the power control apparatus 10, which is very convenient.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power strip comprising:
a plug having a hot line terminal and a neutral line terminal; at least one outlet having a hot line terminal and a neutral line terminal, the neutral line terminal of the at least one outlet electrically connected to the neutral line terminal of the plug; and
a power control apparatus having a connector and an electrical switch with a controlling portion and a switching portion controlled by the controlling portion, the connector connected to the controlling portion of the electrical switch, the hot line terminal of the plug connected to the hot line terminal of the at least one outlet via the switching portion of the electrical switch, if the connector is electrified, the controlling portion controlling the switching portion to turn on thereby controlling the hot line terminal of the plug to be electrically connected to the hot line terminal of the at least one outlet.

2. The power strip as claimed in claim 1, wherein the electrical switch comprises a relay having an inductance coil as the controlling portion and a switch as the switching portion, a power terminal of the connector is connected to a ground terminal of the connector via the inductance coil of the relay, the hot line terminal of the plug is connected to the hot line terminal of the at least one outlet via the switch of the relay.

3. The power strip as claimed in claim 2, wherein the power control apparatus further comprises a light-emitting diode (LED), the anode of the LED is connected to the power terminal of the connector, the cathode of the LED is connected to the ground terminal of the connector via the inductance coil of the relay.

4. The power strip as claimed in claim 3, wherein the power control apparatus further comprises a resistor connected between the power terminal of the connector and the anode of the LED.

5. The power strip as claimed in claim 1, wherein the connector is a universal serial bus (USB) connector.

6. A power strip comprising:
a plug having a hot line terminal and a neutral line terminal; at least one outlet having a hot line terminal and a neutral line terminal, the hot line terminal of the at least one outlet electrically connected to the hot line terminal of the plug; and
a power control apparatus having a connector and an electrical switch, the connector connected to a controlling portion of the electrical switch, the neutral line terminal of the plug connected to the neutral line terminal of the at least one outlet via a switching portion of the electrical switch, if the connector is electrified, the controlling portion controlling the switching portion to turn on thereby controlling the hot line terminal of the plug to be electrically connected to the hot line terminal of the at least one outlet.

7. The power strip as claimed in claim 6, wherein the electrical switch comprises a relay having an inductance coil as the controlling portion and a switch as the switching portion, a power terminal is connected to a ground terminal of the connector via the inductance coil of the relay, the neutral line terminal of the plug is connected to the neutral line terminal of the at least one outlet via the switch of the relay.

8. The power strip as claimed in claim 7, wherein the power control apparatus further comprises a light-emitting diode (LED), the anode of the LED is connected to the power terminal of the connector, the cathode of the LED is connected to the ground terminal of the connector via the inductance coil of the relay.

9. The power strip as claimed in claim 8, wherein the power control apparatus further comprises a resistor connected between the power terminal of the connector and the anode of the LED.

10. The power strip as claimed in claim 6, wherein the connector is a universal serial bus (USB) connector.
